(19) United States
(12) Patent Application Publication
(10) Pub. No.: US 2016/0032766 A1
(43) Pub. Date: Feb. 4, 2016

(54) COMPONENTS WITH MICRO COOLED LASER DEPOSITED MATERIAL LAYER AND METHODS OF MANUFACTURE

(71) Applicant: General Electric Company, Schenectady, NY (US)

(72) Inventors: Ronald Scott Bunker, Waterford, NY (US); William Thomas Carter, Galway, NY (US)

(73) Assignee: General Electric Company, Schenectady, NY (US)

(21) Appl. No.: 13/826,115

(22) Filed: Mar. 14, 2013

(51) Int. Cl. F01D 25/14; F02C 7/18; C04B 35/653; B23K 26/342; B23K 26/60

(52) U.S. Cl. CPC F01D 25/14; B23K 26/342; B23K 26/60; C04B 35/653; F02C 7/18; B33Y 10/00

(57) ABSTRACT

A method of manufacture is provided. The manufacturing method includes using a laser deposition process to apply a laser deposited material on an outer surface of a substrate to form one or more grooves on the outer surface of a substrate. Each groove has a base and an opening and extends at least partially along the outer surface of the substrate, where the substrate has an inner surface that defines at least one hollow, interior space. The manufacturing method further includes disposing an additional material over the laser deposited material, to define one or more channels for cooling the component. The additional material may include additional laser deposited material layers or a coating. Other manufacturing methods and a component are also provided.

### BACKGROUND

The disclosure relates generally to gas turbine engines, and, more specifically, to micro-channel cooling therein.

In a gas turbine engine, air is pressurized in a compressor and mixed with fuel in a combustor for generating hot combustion gases. Energy is extracted from the gases in a high pressure turbine (HPT), which powers the compressor, and in a low pressure turbine (LPT), which powers a fan in a turbofan aircraft engine application, or powers an external shaft for marine and industrial applications.

Engine efficiency increases with temperature of combustion gases. However, the combustion gases heat the various components along their flowpath, which in turn requires cooling thereof to achieve a long engine lifetime. Typically, the hot gas path components are cooled by bleeding air from the compressor. This cooling process reduces engine efficiency, as the bled air is not used in the combustion process.

Gas turbine engine cooling art is mature and includes numerous patents for various aspects of cooling circuits and features in the various hot gas path components. For example, the combustor includes radially outer and inner liners, which require cooling during operation. Turbine nozzles include hollow vanes supported between outer and inner bands, which also require cooling. Turbine rotor blades are hollow and typically include cooling circuits therein, with the blades being surrounded by turbine shrouds, which also require cooling. The hot combustion gases are discharged through an exhaust which may also be lined, and suitably cooled.

In all of these exemplary gas turbine engine components, thin walls of high strength superalloy metals are typically used to reduce component weight and minimize the need for cooling thereof. Various cooling circuits and features are tailored for these individual components in their corresponding environments in the engine. For example, a series of internal cooling passages, or serpentines, may be formed in a hot gas path component. A cooling fluid may be provided to the serpentines from a plenum, and the cooling fluid may flow through the passages, cooling the hot gas path component substrate and any associated coatings. However, this cooling strategy typically results in comparatively low heat transfer rates and non-uniform component temperature profiles.

Micro-channel cooling has the potential to significantly reduce cooling requirements by placing the cooling as close as possible to the heated region, thus reducing the temperature difference between the hot side and cold side of the main load bearing substrate material for a given heat transfer rate.

Typically these micro-channel cooling networks are fabricated by machining or casting channels into a load bearing substrate material. In light of the fabrication of the channels into the load bearing substrate material, additional stress concentrations are introduced.

It would therefore be desirable to provide a micro-channel cooling network and method of fabrication whereby the load bearing substrate material is not substantially compromised during the fabrication process.

### BRIEF DESCRIPTION

These and other shortcomings of the prior art are addressed by the present disclosure, which provides a component with micro cooled laser deposited material layer and methods of manufacture.

In accordance with an embodiment, provided is a manufacturing method. The manufacturing method including providing a substrate material having an outer surface and an inner surface that defines at least one hollow, interior space; using a laser build up process to apply a laser deposited material on the outer surface of the substrate material to form one or more grooves; and disposing an additional material layer on the laser deposited material to define one or more channels for cooling the component. Each groove has a base and an opening and extends at least partially along the outer surface of the substrate. The additional material layer having formed therein one or more cooling exit features in fluid communication with the one or more grooves.

In accordance with another embodiment, provided is a manufacturing method. The method including providing a substrate material having an outer surface and an inner surface that defines at least one hollow, interior space, machining the substrate to selectively remove a portion of the substrate and define one or more cooling supply holes therein, using a laser build up process to apply a laser deposited material on the outer surface of the substrate material to form one or more grooves, and disposing an additional material layer on the laser deposited material to define one or more channels for cooling the component. Each of the one or more cooling supply holes is in fluid communication with the at least one interior space. Each groove has a base and an opening and extends at least partially along the outer surface of the substrate. The additional material layer having formed therein one or more cooling exit features in fluid communication with the one or more grooves. The substrate, the one or more cooling supply holes, the laser deposited material and the cooling exit features provide a cooling network for a component.

In accordance with yet another embodiment, provided is a component. The component including a substrate comprising an outer surface and an inner surface, wherein the inner surface defines at least one hollow, interior space, a laser deposited material applied to the outer surface of the substrate, wherein one or more grooves are formed at least partially in the laser deposited material, an additional material disposed over the laser deposited material to define one or more channels for cooling the component. Each groove extends at least partially along the component and has an opening, and wherein one or more access holes are formed through the base of a respective groove to connect the groove in fluid communication with the respective hollow interior space.

Other objects and advantages of the present disclosure will become apparent upon reading the following detailed description and the appended claims with reference to the accompanying drawings.

### BRIEF DESCRIPTION OF THE FIGURES

The above and other features, aspects, and advantages of the present disclosure will become better understood when the following detailed description is read with reference to the accompanying drawings in which like characters represent like parts throughout the drawings, wherein:

FIG. 1 is a schematic illustration of a gas turbine system in accordance with an embodiment disclosed herein;

FIG. 2 is a schematic cross-section of an example airfoil configuration with cooling channels, in accordance with an embodiment disclosed herein;

FIG. 3 is a schematic cross-section of a portion of a cooling circuit including a micro cooled laser deposited material disposed over the substrate material in accordance with an embodiment disclosed herein;

FIG. 4 schematically depicts a step in a method of fabricating a cooling circuit including a micro cooled laser deposited material in accordance with an embodiment disclosed herein;

FIG. 5 schematically depicts a step in a method of fabricating a cooling circuit including a micro cooled laser deposited material in accordance with an embodiment disclosed herein;

FIG. 6 schematically depicts a step in a method of fabricating a cooling circuit including a micro cooled laser deposited material in accordance with an embodiment disclosed herein;

FIG. 7 is a schematic cross-section of a portion of a cooling circuit including a micro cooled laser deposited material disposed over the substrate material in accordance with an embodiment disclosed herein;

FIG. 8 schematically depicts a step in a method of fabricating a cooling circuit including a micro cooled laser deposited material in accordance with an embodiment disclosed herein;

FIG. 9 schematically depicts a step in a method of fabricating a cooling circuit including a micro cooled laser deposited material in accordance with an embodiment disclosed herein;

FIG. 10 schematically depicts a step in a method of fabricating a cooling circuit including a micro cooled laser deposited material in accordance with an embodiment disclosed herein;

FIG. 11 schematically depicts a step in a method of fabricating a cooling circuit including a micro cooled laser deposited material in accordance with an embodiment disclosed herein;

FIG. 12 is a schematic cross-section of a portion of a cooling circuit including a plurality of re-entrant shaped grooves formed in a laser deposited material and with a coating disposed over the laser deposited material to seal the plurality of re-entrant shaped grooves in accordance with an embodiment disclosed herein;

FIG. 13 is a schematic isometric view illustrating a plurality of re-entrant shaped channels formed in a laser deposited material and having a plurality of cooling exit features extending through a coating disposed on the laser deposited material in according with an embodiment disclosed herein; and

FIG. 14 is a schematic block diagram illustrating the method of fabrication in accordance with an embodiment disclosed herein.

### DETAILED DESCRIPTION

The disclosure will be described for the purposes of illustration only in connection with certain embodiments; however, it is to be understood that other objects and advantages of the present disclosure will be made apparent by the following description of the drawings according to the disclosure. While preferred embodiments are disclosed, they are not intended to be limiting. Rather, the general principles set forth herein are considered to be merely illustrative of the scope of the present disclosure and it is to be further understood that numerous changes may be made without straying from the scope of the present disclosure.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The modifier “about” used in connection with a quantity is inclusive of the stated value, and has the meaning dictated by context, (e.g., includes the degree of error associated with measurement of the particular quantity). In addition, the term “combination” is inclusive of blends, mixtures, alloys, reaction products, and the like.

Moreover, in this specification, the suffix “(s)” is usually intended to include both the singular and the plural of the term that it modifies, thereby including one or more of that term (e.g., “the passage hole” may include one or more passage holes, unless otherwise specified). Reference throughout the specification to “one embodiment,” “another embodiment,” “an embodiment,” and so forth, means that a particular element (e.g., feature, structure, and/or characteristic) described in connection with the embodiment is included in at least one embodiment described herein, and may or may not be present in other embodiments. Similarly, reference to “a particular configuration” means that a particular element (e.g., feature, structure, and/or characteristic) described in connection with the configuration is included in at least one configuration described herein, and may or may not be present in other configurations. In addition, it is to be understood that the described inventive features may be combined in any suitable manner in the various embodiments and configurations.

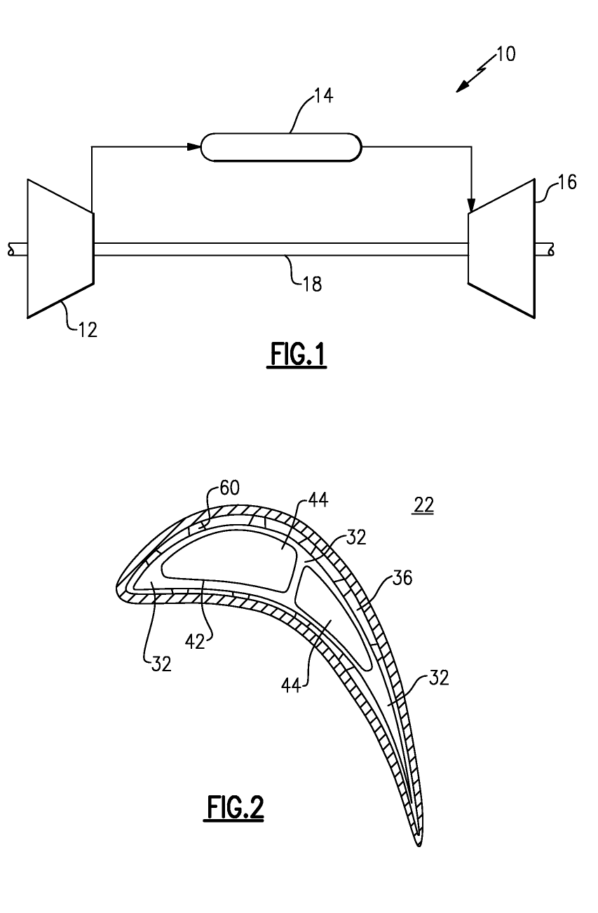

FIG. 1 is a schematic diagram of a gas turbine system 10. The system 10 may include one or more compressors 12, combustors 14, turbines 16, and fuel nozzles (not shown). The compressor 12 and turbine 16 may be coupled by one or more shaft 18. The shaft 18 may be a single shaft or multiple shaft segments coupled together to form shaft 18.

The gas turbine system 10 may include a number of hot gas path components 22. A hot gas path component is any component of the system 10 that is at least partially exposed to a high temperature flow of gas through the system 10. For example, bucket assemblies (also known as blades or blade assemblies), nozzle assemblies (also known as vanes or vane assemblies), shroud assemblies, transition pieces, retaining rings, and compressor exhaust components are all hot gas path components. However, it should be understood that the hot gas path component 22 of the present disclosure is not limited to the above examples, but may be any component that is at least partially exposed to a high temperature flow of gas. Further, it should be understood that the hot gas path component 22 of the present disclosure is not limited to components in gas turbine systems 10, but may be any piece of machinery or component thereof that may be exposed to high temperature flows.

When a hot gas path component 22 is exposed to a hot gas flow, the hot gas path component 22 is heated by the hot gas flow and may reach a temperature at which the hot gas path component 22 is substantially degraded or fails. Thus, in order to allow system 10 to operate with hot gas flow at a high temperature, increasing the efficiency, performance and/or life of the system 10, a cooling system for the hot gas path component 22 is required.

In general, the cooling system of the present disclosure includes a series of small channels, or micro-channels, formed on the surface of the hot gas path component 22. For industrial sized power generating turbine components, “small” or “micro” channel dimensions would encompass approximate depths and widths in the range of 0.25 mm to 1.5 mm, while for aviation sized turbine components channel dimensions would encompass approximate depths and widths in the range of 0.1 mm to 0.5 mm. The hot gas path component may be provided with a protective coating. A cooling fluid may be provided to the channels from a plenum, and the cooling fluid may flow through the channels, cooling the hot gas path component 22.

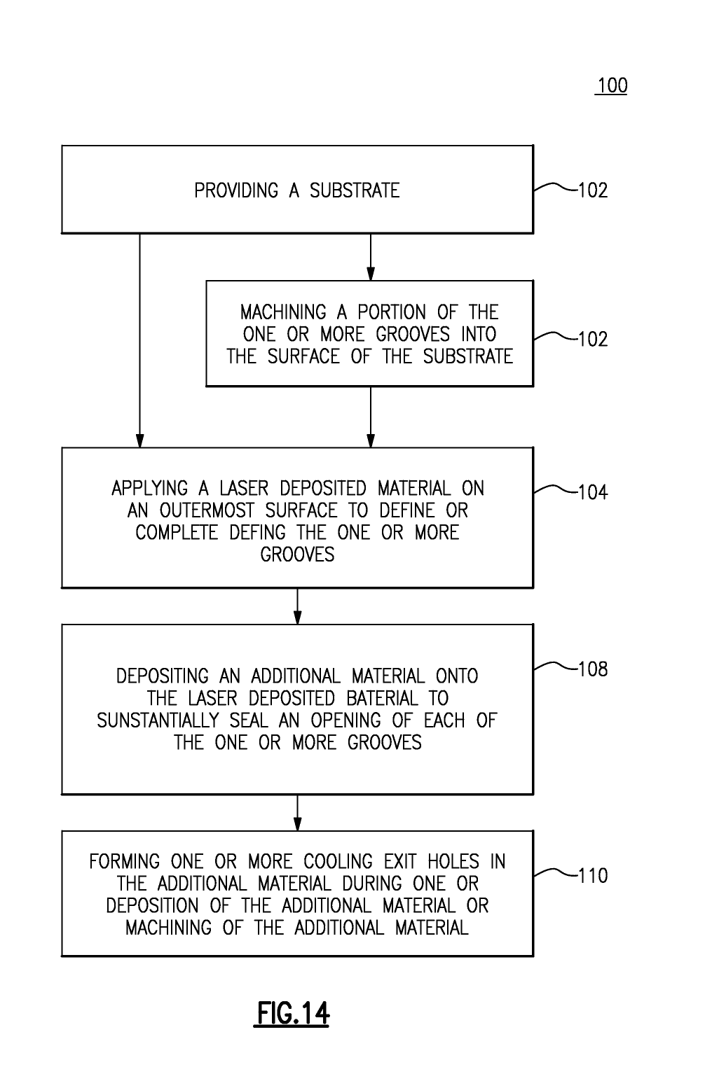

Alternative manufacturing methods are described with reference to FIGS. 3-12. As indicated for example in FIGS. 3-6, the manufacturing method may include defining one or more grooves 30 on an outer (uppermost) surface 34 of a substrate 32 in a laser deposited material layer 36 (described presently). Further, an additional material 46, such as a coating, may be deposited on the laser deposited material 36. As indicated for example in FIGS. 7-11, the manufacturing method may include defining at least a portion of the one or more grooves 30 into the substrate 32 and a remaining portion of the one or more grooves 30 in the laser deposited material layer 36 (described presently). The manufacturing method may further include applying laser deposited material in a manner so as to substantially seal the grooves. An optional coating may thereafter be deposited on the laser deposited material. As indicated, for example, in FIGS. 3 and 7 each groove 30 has a base 38 and an opening 40 and extends at least partially along the outer surface 34 of the substrate 32. As shown in FIG. 2, the substrate 32 has an inner surface 42 that defines at least one hollow, interior space 44. It should be understood that embodiments of the manufacturing method are provided for purposes of disclosure, and that further combinations of the steps provided herein are anticipated by this disclosure.

In an embodiment, the substrate 32 is cast prior to forming the one or more grooves 30. As discussed in U.S. Pat. No. 5,626,462, Melvin R. Jackson et al., “Double-wall airfoil,” which is incorporated herein in its entirety, substrate 32 may be formed from any suitable material. Depending on the intended application for the hot gas component 22, this could include Ni-base, Co-base and Fe-base superalloys. The Ni-base superalloys may be those containing both γ and γ′ phases, particularly those Ni-base superalloys containing both γ and γ′ phases wherein the γ′ phase occupies at least 40% by volume of the superalloy. Such alloys are known to be advantageous because of a combination of desirable properties including high temperature strength and high temperature creep resistance. The substrate material may also comprise a NiAl intermetallic alloy, as these alloys are also known to possess a combination of superior properties including high temperature strength and high temperature creep resistance that are advantageous for use in turbine engine applications used for aircraft. In the case of Nb-base alloys, coated Nb-base alloys having superior oxidation resistance will be preferred, particularly those alloys comprising Nb-(27-40)Ti-(4.5-10.5)Al-(4.5-7.9)Cr-(1.5-5.5)Hf-(0-6)V, where the composition ranges are in atom per cent. The substrate material may also comprise a Nb-base alloy that contains at least one secondary phase, such as a Nb-containing intermetallic compound comprising a silicide, carbide or boride. Such alloys are composites of a ductile phase (i.e., the Nb-base alloy) and a strengthening phase (i.e., a Nb-containing intermetallic compound). For other arrangements, the substrate material comprises a molybdenum based alloy, such as alloys based on molybdenum (solid solution) with Mo₅SiB₂ and Mo₃Si second phases. For other configurations, the substrate material comprises a ceramic matrix composite, such as a silicon carbide (SiC) matrix reinforced with SiC fibers. For other configurations the substrate material comprises a TiAl-based intermetallic compound.

Referring now to FIGS. 3-6, an embodiment of a manufacturing method is disclosed herein. More particularly, as illustrated in FIG. 3, provided is the substrate 32 as previously described. The method includes using a laser sintering or deposition process to apply the laser deposited material 36 over the substrate 32, and more particularly on the outer surface 34 of the substrate, to define the one or more grooves 30. The process may include one of a direct metal laser melting (DMLM) or a laser engineered net shape (LENS) process to build the three-dimensional groove structures. Laser sintering or deposition processes include many layers being built up to form a complete structure. As an example, a typical layer thickness may be on the order of 1 micron as formed by the use of 7 micron sized powder or wire. As example, 250 layers would be required to define a micro channel cooled complete laser deposited material 36 that is 0.010″ thick.

As best illustrated in FIG. 5, deposition of the laser deposited material 36 using a DMLM process typically includes, a computer aided drafting (CAD) program to be utilized and provide slicing of a computer model into a plurality of thin layers. A metal powder is then deposited onto the substrate 32 and a laser is provided to melt the powder in areas corresponding to a first layer proximate the substrate 32. The laser melted metal powder solidifies almost immediately to form a portion of the laser deposited material 36 on a portion of the substrate 32, so as to define the one or more grooves 30. Any unmelted powder surrounding the solidified metal portion will remain as loose powder. The laser deposited material 36 may be metallurgically bonded to the substrate 32. Additional metal powder is then added and the laser melts the next layer, simultaneously fusing it to the first layer of the laser deposited material 36. This build-up process is continued until the laser deposited material 36 has been fused forming a complete structure, defining therein the one or more grooves 30, and any remaining unmelted metal powder is removed.

In an alternate LENS process, a laser is used to heat a metal material to a melting stage, creating a weld pool. A powdered or solid (for example, wire, tape or foil) feedstock material is fed into the weld pool to add metal material. The laser deposited material 36 may be metallurgically bonded to the substrate 32. Control of the weld pool location and metal feedstock material enables a plurality of layers of laser deposited material 36 to be built up. As illustrated in FIG. 5, this build-up process is continued until the laser deposited material 36 has been fused forming a complete structure, defining therein the one or more grooves 30. During the laser deposition process, the material is built up in a manner so as to define the one or more grooves 30, wherein each groove has a base 38 and an opening 40 and extends at least partially along the outer surface 34 of the substrate 32. The distance across the top of the groove, the opening 40, may vary based on the specific application. However, for certain configurations, the distance across the opening 40 of each of the one or more grooves 30 is in a range of about 0-25 mil (0.0-0.6 mm) prior to deposition of the additional material 46.

For certain configurations, the substrate 32 and the laser deposited material 36 comprise the same material. For example, the substrate 32 may comprise a first material, and the laser deposited material 36 may be applied by applying a laser to the first material in a powdered form. For these configurations, the first material may comprise one of a number of nickel-based, cobalt-based alloys, or iron base alloys, including without limitations nickel-base, cobalt-base and iron-base superalloys, as described above with reference to U.S. Pat. No. 5,626,462, Melvin R. Jackson et al.

For other configurations, the substrate 32 and the laser deposited material 36 may comprise different but compatible materials, such that the laser deposited material will bond well with the substrate material. For example the substrate 32 may comprise a first material, and the laser deposited material 36 may be applied by applying a laser to a second material in a powdered form, where the first and second materials are different materials and where the laser deposited material (second material) is a compatible material that will bond well with the substrate material (first material). The first and second materials may be selected from a number of nickel-based, cobalt-based alloys, or iron base alloys, including without limitations nickel-base, cobalt-base and iron-base superalloys, as described above with reference to U.S. Pat. No. 5,626,462, Melvin R. Jackson et al. For particular configurations, the second material may comprise the material used for the additional material 46.

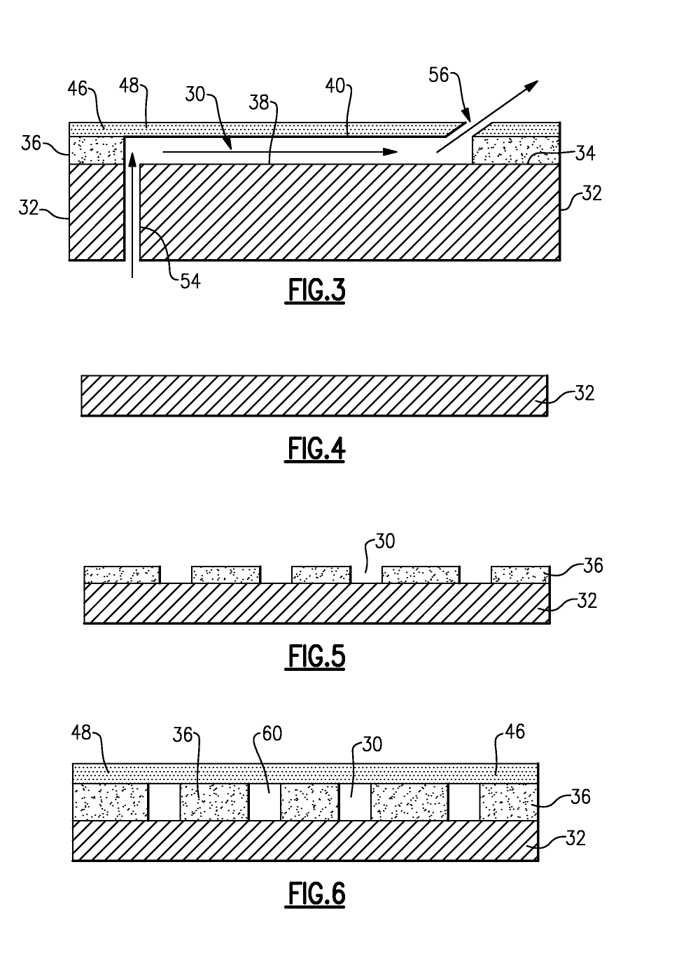

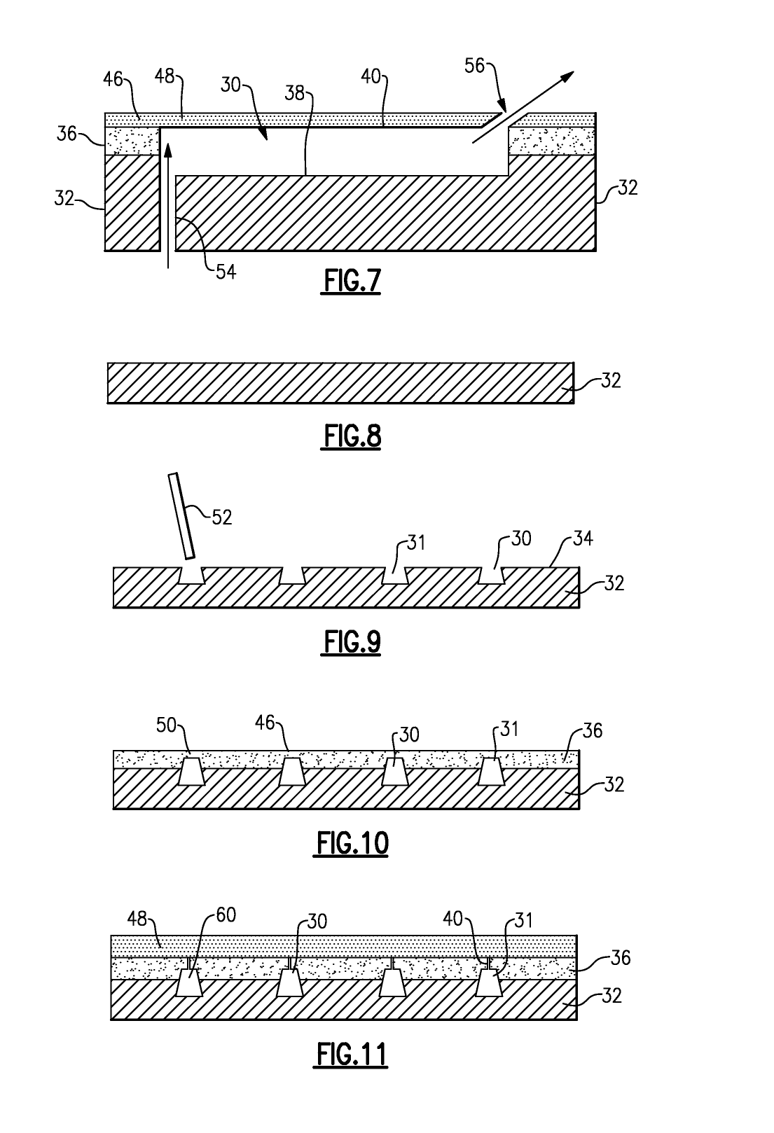

Referring now to FIG. 6, the manufacturing method may further include disposing the additional material 46 over the laser deposited material 36 to seal the one or more grooves 30 formed therein and define the one or more cooling channels 60. The additional material 46 comprises a suitable material and is bonded to the laser deposited material 36. The additional material 46 may be described as a structural coating 48 that is deposited in a manner so as to substantially seal the one or more grooves 30, and define the one or more cooling channels 60. More particularly, the coating 48 is deposited on an uppermost surface of the laser deposited material 36 and extending to substantially seal the one or more grooves 30. As discussed in U.S. Publication No. 2012/0114868, Ronald Scott Bunker et al., entitled “Method of Fabricating a Component Using a Fugitive Coating,” which is incorporated herein in its entirety, a sacrificial filler material may be employed to provide for deposition of the coating 48 in a manner to substantially seal the one or more grooves 30.

For particular configurations, the coating 48 has a thickness in the range of 0.1-2.0 millimeters, and more particularly, in the range of 0.2 to 1 millimeter, and still more particularly 0.2 to 0.5 millimeters for industrial components. For aviation components, this range is typically 0.1 to 0.25 millimeters. However, other thicknesses may be utilized depending on the requirements for a particular component 22. In addition, the coating 48 when formed using an ion plasma deposition may have thicknesses of less than about 0.5 mm, but for a thermal plasma spray (such as high velocity oxygen fuel) coating, the thickness of the structural coating 48 may be less than about 1 mm.

The coating 48 comprises structural coatings and may further include optional additional coating(s). The coating layer(s) may be deposited using a variety of techniques. For particular processes, the structural coating layer(s) are deposited by performing an ion plasma deposition (cathodic arc). Example ion plasma deposition apparatus and method are provided in commonly assigned, US Published Patent Application No. 10,080,138,529, Weaver et al, “Method and apparatus for cathodic arc ion plasma deposition,” which is incorporated by reference herein in its entirety. Briefly, ion plasma deposition comprises placing a consumable cathode formed of a coating material into a vacuum environment within a vacuum chamber, providing a substrate 32 within the vacuum environment, supplying a current to the cathode to form a cathodic arc upon a cathode surface resulting in arc-induced erosion of coating material from the cathode surface, and depositing the coating material from the cathode upon the surface of the laser deposited material 36.

Non-limiting examples of a coating deposited using ion plasma deposition include structural coatings, as well as bond coatings and oxidation-resistant coatings, as discussed in greater detail below with reference to U.S. Pat. No. 5,626,462, Jackson et al., “Double-wall airfoil.” For certain hot gas path components 22, the structural coating comprises a nickel-based or cobalt-based alloy, and more particularly comprises a superalloy or a (Ni,Co)CrAlY alloy. For example, where the substrate material is a Ni-base superalloy containing both γ and γ′ phases, structural coating may comprise similar compositions of materials, as discussed in greater detail below with reference to U.S. Pat. No. 5,626,462.

For other process configurations, a structural coating is deposited by performing at least one of a thermal spray process and a cold spray process. For example, the thermal spray process may comprise combustion spraying or plasma spraying, the combustion spraying may comprise high velocity oxygen fuel spraying (HVOF) or high velocity air fuel spraying (HVAF), and the plasma spraying may comprise atmospheric (such as air or inert gas) plasma spray, or low pressure plasma spray (LPPS, which is also known as vacuum plasma spray or VPS). In one non-limiting example, a (Ni,Co)CrAlY coating is deposited by HVOF or HVAF. Other example techniques for depositing the structural coating include, without limitation, sputtering, electron beam physical vapor deposition, electroless plating, and electroplating.

For certain configurations, it is desirable to employ multiple deposition techniques for depositing structural and optional additional coating layers. For example, a first structural coating layer may be deposited using an ion plasma deposition, and a subsequently deposited layer and optional additional layers (not shown) may be deposited using other techniques, such as a combustion spray process or a plasma spray process. Depending on the materials used the use of different deposition techniques for the coating layers may provide benefits in properties, such as, but not restricted to strain tolerance, strength, adhesion, and/or ductility. Beneficially, the metallurgical bond between the substrate 32 and the laser deposited material 36 will be stronger than that associated, for example, with a coating like NiCrAlY deposited by a thermal plasma method. Thus, if a thermal plasma coating is applied over the laser deposited material 36, issues of insufficient strength in the thermal plasma coating will be reduced or eliminated.

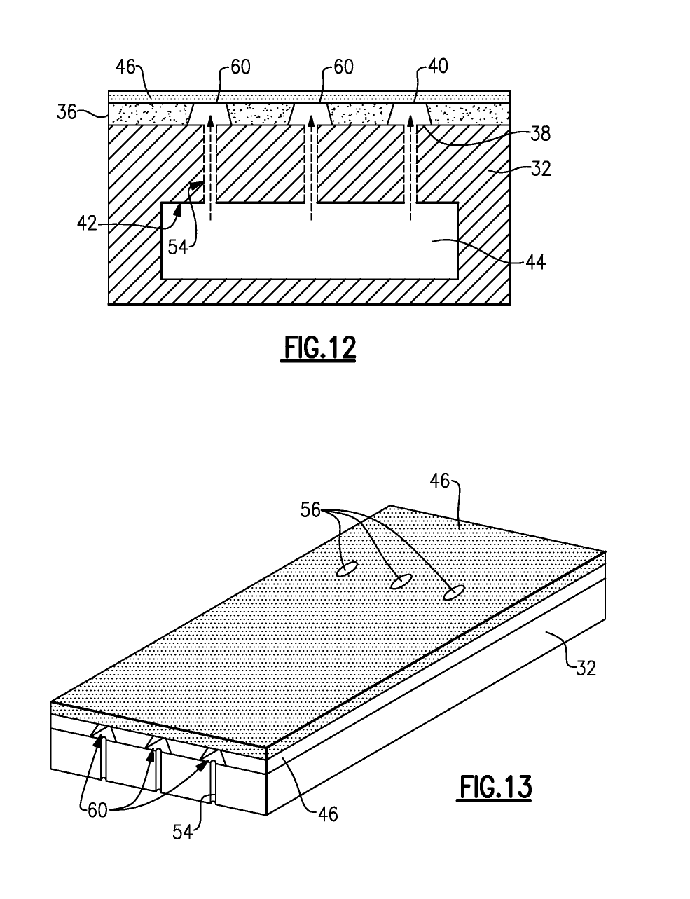

Another method of manufacture is described with reference to FIGS. 7-11. As indicated, for example, in FIG. 9, in contrast to the previously disclosed embodiment, the method of manufacture comprises forming the one or more grooves 30 including at least a portion extending a depth into the outer surface 34 of a substrate 32. As shown in FIG. 7, the substrate 32 has an inner surface 34 that defines the at least one hollow, interior space 44. The substrate is described in more detail above. For the example arrangements shown in FIGS. 10 and 11, upon completion, each of the one or more grooves 30 narrows at the respective opening 40 thereof, such that each groove 30 comprises a re-entrant shaped groove 31. The formation of re-entrant-shaped grooves 31 is described in commonly assigned, U.S. Pat. No. 8,387,245, Ronald Scott Bunker et al., “Components with re-entrant shaped cooling channels and methods of manufacture.”

As previously described with regard to FIG. 3, provided is the substrate 32. In this particular embodiment, at least a portion of the one or more grooves 30 are initially formed at a depth into the outer surface 34 of the substrate 32. More particularly, as best illustrated in FIG. 9, the method includes a subtractive process into the outer surface 34 of the substrate 32 so as to form a portion of the one or more grooves extending thereunto. Alternatively, the substrate 32 may be cast to include a portion of the one or more grooves 30 formed therein the outermost surface 34.

In the illustrated embodiment, a portion of the one or more grooves 30 may be formed using a variety of techniques. Example techniques for forming a portion of the groove(s) 30 into the substrate 32 include abrasive liquid jet, plunge electrochemical machining (ECM), electric discharge machining (EDM) with a spinning electrode (milling EDM), and laser machining. Example laser machining techniques are described in commonly assigned, U.S. patent application Ser. No. 12/697,005, “Process and system for forming shaped air holes” filed Jan. 29, 2010, which is incorporated by reference herein in its entirety. Example EDM techniques are described in commonly assigned U.S. patent application Ser. No. 12/790,675, “Articles which include chevron film cooling holes, and related processes,” filed May 28, 2010, which is incorporated by reference herein in its entirety.

For particular processes, a portion of each of the grooves 30 is formed using an abrasive liquid jet 52 (FIG. 9). Example water jet drilling processes and systems are provided in commonly assigned U.S. patent application Ser. No. 12/790,675, “Articles which include chevron film cooling holes, and related processes,” filed May 28, 2010, which is incorporated by reference herein in its entirety. As explained in U.S. patent application Ser. No. 12/790,675, the water jet process typically utilizes a high-velocity stream of abrasive particles (e.g., abrasive “grit”), suspended in a stream of high pressure water. The pressure of the water may vary considerably, but is often in the range of about 35-620 MPa. A number of abrasive materials can be used, such as garnet, aluminum oxide, silicon carbide, and glass beads. Beneficially, the capability of abrasive liquid jet machining techniques facilitates the removal of material in stages to varying depths, with control of the shaping. This allows the portion of each of the one or more grooves 30 formed into the substrate 32 surface 34 to be drilled either having substantially parallel sides, or angled, so as to form re-entrant shape grooves 31. In addition, a plurality of access holes 54 (FIG. 7) may be formed into the substrate 32 and in communication with each of the one or more grooves 30 as a straight hole of constant cross section, a shaped hole (elliptical etc.), or a converging or diverging holes.

In addition, and as explained in U.S. patent application Ser. No. 12/790,675, the water jet system can include a multi-axis computer numerically controlled (CNC) unit. The CNC systems themselves are known in the art, and described, for example, in U.S. Patent Publication 1005/0013926 (S. Rutkowski et al), which is incorporated herein by reference. CNC systems allow movement of the cutting tool along a number of X, Y, and Z axes, as well as rotational axes.

In an embodiment, each of the portions of the one or more grooves 30 formed into the surface 34 of the substrate 32 to a prescribed depth may be formed by directing the abrasive liquid jet 52 at a lateral angle relative to the surface 34 of the substrate 32 in a first pass of the abrasive liquid jet 52 and then making a subsequent pass at an angle substantially opposite to that of the lateral angle, such that each groove begins to narrow toward the opening 40 of the groove. In combination with a portion of the one or more grooves 30 formed in the laser deposited material 36 (described presently) the groove will comprise a re-entrant shaped groove 31. Typically, multiple passes will be performed to achieve the desired depth and width for the groove. This technique is described in commonly assigned, U.S. patent application Ser. No. 12/943,624, Bunker et al., “Components with re-entrant shaped cooling channels and methods of manufacture,” which is incorporated by reference herein in its entirety. In addition, the step of forming the one or more re-entrant shaped grooves 31 may further comprise performing an additional pass where the abrasive liquid jet 52 is directed toward the base 38 of the groove 31 at one or more angles between the lateral angle and a substantially opposite angle, such that material is removed from the base 38 of the groove 30. In an alternate embodiment, the portion of the grooves 30 formed into the surface 34 of the substrate 32 may include substantially parallel sides, generally similar to the grooves 30 of FIGS. 3-6.

Similar to the methods described above with reference to FIGS. 3-6, the manufacturing method further includes using a laser sintering or deposition process to apply a laser deposited material 36 over the substrate 32, to further define the one or more grooves 30, and ultimately the one or more channels 60 for cooling the component 22. More particularly, subsequent to formation of a portion of the one or more grooves 30 into the surface 34 of the substrate 32, the laser deposited material 36 is applied in a manner such as those previously described with reference to FIGS. 3-6. More particularly, the laser deposited material 36 may be applied using either a DMLM or LENS build up procedure so as to further define a remaining portion of the one or more grooves 30.

For the arrangement shown in FIG. 10, the laser deposited material 36 is deposited in a manner so as to further define the one or more grooves 30. In an embodiment, additional material 46 may be added to substantially seal the openings 40 of the one or more grooves 30. As previously indicated, the distance across the top of the groove, the opening 40, may vary based on the specific application. In an embodiment, the distance across the opening 40 of each of the one or more grooves 30 is in a range of about 0-15 mil (0.0-0.4 mm). Beneficially, this facilitates applying the additional material 46 without the use of a sacrificial filler (not shown). In an embodiment, the additional material 46 may be a coating 50, as previously described, or additional laser deposited material 52, whereby the additional laser deposited material 52 seals the opening 40 during the deposition process. In this particular embodiment, the laser deposited material 36 may not completely seal the opening 40. However, the opening 40 is sufficiently small, such that laser deposited material 36 facilitates the deposition of the additional material 46 without the use of a sacrificial filler (not shown), by forming a partial cover with some minor residual gap near the middle for the structural coating to bridge over. In the illustrated embodiment, the additional laser deposited material 50 is deposited without the use of additional fillers. For the arrangement shown in FIG. 11, an optional coating 48 may further be included.

As indicated in FIGS. 3, 7, 11 and 12, for example, the manufacturing method may further include forming the one or more access holes 54 through the base 38 of a respective one of the grooves 30 to connect the respective groove 30 in fluid communication with the respective hollow interior space 44. It should be noted that the access holes 54 are holes and are thus not coextensive with the channels 60, as indicated in FIGS. 3 and 7, for example. Example techniques for forming the access holes are described in commonly assigned, U.S. patent application Ser. No. 13/210,697, Bunker et al., “Components with cooling channels and methods of manufacture,” which is incorporated by reference herein in its entirety. As best illustrated in FIGS. 3, 7 and 12, one or more cooling exit features 56 are defined in the additional material 46. In an embodiment, the cooling exit features 56 are formed by machining the additional material 46. In an alternate embodiment, the cooling exit features 56 are formed during deposition of the additional material 46 on the laser deposited material 36. The cooling exit features 56 connect the respective groove 30 in fluid communication with a means for cooling exit flow. It should be noted that in this particular embodiment, the one or more cooling exit features 56 are configured as holes and are not coextensive with the channels 60, as indicated in FIGS. 3, 7 and 12, for example. It should be understood that the cooling exit features 56 can take on many alternate forms, including exit trenches that may connect the cooling exits of several cooling channels. Exit trenches are described in commonly assigned U.S. Patent Publication No. 2011/0145371, R. Bunker et al., “Components with Cooling Channels and Methods of Manufacture,” which is incorporated by reference herein in its entirety.

Referring now to FIG. 13, illustrated is a flow chart depicting one implementation of a method 100 of making a component 22 including one or more cooling channels 60 according to one or more embodiments shown or described herein. The method 100 includes manufacturing the component 22 to ultimately include one or more cooling channels 60 by initially providing a substrate 32, at step 102, and applying on an outermost surface 34 a laser deposited material 36 to define one or more grooves 30, at step 104. Optionally, a portion of the one or more grooves 30 may be initially defined into the surface of the substrate 32, at step 106, prior to applying the laser deposited material. Next, at step 108, an additional material 46, such as a coating 50, or additional laser deposited material 52, is deposited to substantially seal an opening of each of the one or more grooves 30 defined by the laser deposited material 36. As indicated, in an embodiment the additional laser deposited material 52 may provide for substantial sealing of the one or more grooves 30 and may or may not include a later deposited coating 50. The one or more cooling access holes 54 are defined in the substrate 32 in a machining step, prior to sealing the one or more grooves 30. The one or more cooling access holes 54 are provided in fluidic communication with the interior space 44. The fabrication of the one or more grooves 30 may include patterns configured in a grid-like geometry or in any arbitrary geometry, including a curved (2D or 3D space) geometry, intersecting, or the like, as long as dimensional requirements are maintained. In addition, interim machining steps may be included after formation of the one or more grooves 30 to arrive at a desirable shape.

Finally, in a step 110, one or more cooling exit features 56 are formed in one or more of the additional material 46 and/or the laser deposited material 36. In an embodiment, the one or more cooling exit features 56 are machined in any locations and pattern in the coating 50 to provide fluid communication with the cooling pattern. In another embodiment, the one or more cooling exit features 56 are formed during deposition of the additional laser deposited material 52 in any locations and pattern, to provide fluid communication with the cooling pattern. After processing, provided is the component 22 including the interior space 44, the one or more cooling access holes 54 in fluidic communication with the interior space 44 and one or more cooling channels 60 formed in a laser deposited material 36 in fluidic communication with the one or more cooling access holes 54 and the one or more cooling exit features 56. It should be understood that the cooling exit features 56 can take on many alternate forms, including exit trenches that may connect the cooling exits of several cooling channels. Exit trenches are described in commonly assigned U.S. Patent Publication No. 2011/0145371, R. Bunker et al., “Components with Cooling Channels and Methods of Manufacture,” which is incorporated by reference herein in its entirety.

Disclosed is a method of fabricating cooling channels in a component utilizing laser sintering or deposition processes, such as Direct Metal Laser Melting (DMLM) or Laser Engineered Net Shape (LENS), to directly deposit and sinter (bond and densify) or fuse a micro channel cooling layer onto the outer surface of a cast or fabricated component, such as a turbine component. The micro channels are formed as part of the DMLM or LENS build up process and in an embodiment, do not require a pre-machining step. Channels are not machined into the load bearing substrate, typically a cast component, and therefore no additional stress concentration is introduced in the substrate material. In an alternate embodiment, pre-machining at least a portion of the micro-channels into the substrate surface may be included. The discretized and programmed sintering process or pattern can be held to very small incremental position steps, resulting in very small groove sizes and top openings. The small groove size and small top openings facilitates the direct application of a covering coating by other methods to seal the channels (e.g. thermal spray or ion plasma deposition) or alternately the addition of additional laser deposited material to seal the opening.

Beneficially, the above described methods provides a cooling network for a component including the substrate, the one or more cooling supply holes, the one or more cooling channels formed in the laser deposited material and the cooling exit features. The method provides a high strength metallurgical bond of the laser deposited material having defined therein the micro channels to assure the durability of the micro channels for the resulting micro channel cooled components.

The foregoing description of several embodiments of the present disclosure has been presented for purposes of illustration. Although the disclosure has been described and illustrated in detail, it is to be clearly understood that the same is intended by way of illustration and example only and is not to be taken by way of limitation. Obviously many modifications and variations of the present disclosure are possible in light of the above teaching. Accordingly, the spirit and scope of the present disclosure are to be limited only by the terms of the appended claims.

1. A manufacturing method comprising:
providing a substrate material having an outer surface and an inner surface that defines at least one hollow, interior space;
using a laser build up process to apply a laser deposited material on the outer surface of the substrate material to form one or more grooves wherein each groove has a base and an opening and extends at least partially along the outer surface of the substrate; and
disposing an additional material on the laser deposited material to define one or more channels for cooling the component, the additional material layer having formed therein one or more cooling exit features in fluid communication with the one or more grooves, and wherein the substrate comprises a first material and the laser deposited material is applied by applying a laser to a second material, wherein the first and second materials are different materials,
further comprising forming at least a portion of each of the one or more grooves to a depth into the outer surface of the substrate, and
further comprising one of using an abrasive liquid jet, plunge electrochemical machining (ECM), electric discharge machining (EDM) with a spinning electrode, laser machining or casting to form at least a portion of each of the one or more grooves into the outer surface of the substrate, wherein at least one of the one or more grooves define a straight hole of constant cross section, a shaped elliptical hole, or a converging or diverging holes.

2. The manufacturing method of claim 1, wherein depositing an additional material to define one or more channels comprises disposing a coating over the laser deposited material to substantially seal the opening of the one or more grooves.

3. The manufacturing method of claim 1, wherein depositing an additional material to define one or more channels comprises applying additional laser deposited material over the previously applied laser deposited material to substantially seal the opening of the one or more grooves.

4. The manufacturing method of claim 1, wherein using a laser build up process includes one of a direct metal laser melting (DMLM) process or a Laser Engineered Net Shape (LENS) process.

5. The manufacturing method of claim 1, wherein the cooling exit features are formed by one of machining or during deposition of the additional material on the laser deposited material.

6. (canceled)

7. (canceled)

8. The manufacturing method of claim 1, wherein using the laser build up process to apply a laser deposited material on the outer surface of the substrate material is configured such that each groove narrows at the opening of the groove and thus comprises a re-entrant shaped groove.

9. The manufacturing method of claim 1, further comprising forming one or more access holes through the base of a respective one of the grooves to connect the respective groove in fluid communication with respective ones of the at least one hollow interior space.

10. (canceled)

11. A manufacturing method comprising:
providing a substrate material having an outer surface and an inner surface that defines at least one hollow, interior space;
machining the substrate to selectively remove a portion of the substrate and define one or more cooling supply holes therein, each of the one or more cooling supply holes in fluid communication with the at least one interior space;
using a laser build up process to apply a laser deposited material on the outer surface of the substrate material to form one or more grooves wherein each groove has a base and an opening and extends at least partially along the outer surface of the substrate; and
disposing an additional material layer on the laser deposited material to define one or more channels for cooling the component, the additional material layer having formed therein one or more cooling exit features in fluid communication with the one or more grooves,
wherein the substrate, the one or more cooling supply holes, the laser deposited material and the cooling exit features provide a cooling network for a component, and wherein the substrate comprises a first material and the laser deposited material is applied by applying a laser to a second material, wherein the first and second materials are different materials,
further comprising forming at least a portion of each of the one or more grooves to a depth into the outer surface of the substrate, and
forming at least a portion of each of the one or more grooves into the outer surface of the substrate using an abrasive liquid jet, plunge electrochemical machining (ECM), electric discharge machining (EDM) with a spinning electrode, laser machining or by casting wherein at least one of the one or more grooves define a straight hole of constant cross section, a shaped elliptical hole, or a converging or diverging holes.

12. The manufacturing method of claim 11, wherein depositing an additional material to define one or more channels comprises disposing a coating over the laser deposited material and the one or more grooves to substantially seal the opening of the one or more grooves.

13. The manufacturing method of claim 11, wherein depositing an additional material to define one or more channels comprises applying additional laser deposited material over the previously applied laser deposited material to substantially seal the opening of the one or more grooves.

14. The manufacturing method of claim 11, wherein using a laser build up process includes one of a direct metal laser melting (DMLM) process or a Laser Engineered Net Shape (LENS) process.

15. (canceled)

16. The manufacturing method of claim 11, wherein using the laser build up process to apply a laser deposited material on the outer surface of the substrate material is configured such that each groove narrows at the opening of the groove and thus comprises a re-entrant shaped groove.

17. (canceled)

18. A component comprising:
a substrate comprising an outer surface and an inner surface, wherein the inner surface defines at least one hollow, interior space;
a laser deposited material applied to the outer surface of the substrate, wherein one or more grooves are formed at least partially in the laser deposited material, wherein each groove extends at least partially along the component and has an opening and a base, and wherein one or more cooling access holes are formed through the base of a respective groove, to connect the groove in fluid communication with the respective hollow interior space; and
an additional material disposed over the laser deposited material to define one or more channels for cooling the component,
at least a portion of each of the one or more grooves to a depth into the outer surface of the substrate, and
further comprising one of using an abrasive liquid jet, plunge electrochemical machining (ECM), electric discharge machining (EDM) with a spinning electrode, laser machining or casting to form at least a portion of each of the one or more grooves into the outer surface of the substrate, wherein at least one of the one or more grooves define a straight hole of constant cross section, a shaped elliptical hole, or a converging or diverging holes.

19. The component of claim 18, wherein each of the respective one or more grooves narrows at the respective opening thereof, such that each groove comprises a re-entrant shaped groove.

20. The component of claim 18, wherein the additional material disposed over the laser deposited material to define the one or more channels comprises a coating disposed over the laser deposited material to substantially seal the opening of the one or more grooves.

21. The component of claim 18, wherein the additional material disposed over the laser deposited material to define the one or more channels comprises additional laser deposited material applied over the previously applied laser deposited material to substantially seal the opening of the one or more grooves.

22. The component of claim 18, wherein the additional material and the laser deposited material comprise the same material.
